(19) United States
(12) Patent Application Publication
(10) Pub. No.: US 2025/0198825 A1
(43) Pub. Date: Jun. 19, 2025

(54) DISPENSER FOR LIQUIDS

(71) Applicant: Aptar Radolfzell GmbH, Radolfzell (DE)

(72) Inventors: Jörg KOHNLE, Villingen-Schwenningen (DE); Joachim KÖRNER, Uhldingen-Mühlhofen (DE)

(21) Appl. No.: 18/851,875

(22) PCT Filed: Mar. 21, 2023
(86) PCT No.: PCT/EP2023/057212

§ 371 Date: Sep. 27, 2024

(30) Foreign Application Priority Data
Mar. 28, 2022 (EP) 22164740.7

(51) Int. Cl. G01F 23/296; B05B 11/02

(52) U.S. Cl. CPC G01F 23/296; B05B 11/02

(57) ABSTRACT

A dispenser for discharging liquids, having a liquid store and a discharge opening for dispensing the liquid. The liquid store is configured such that its internal volume is reduced in size as liquid is being dispensed. To detect a filing level of the liquid store, the dispenser has two housing sections, the distance between which changes as the internal volume of the liquid store is reduced in size. The dispenser has a distance sensor arrangement for detecting the distance between the housing sections.

### FIELD OF APPLICATION AND PRIOR ART

The invention relates to a dispenser for discharging liquids, in particular for discharging pharmaceutical and cosmetic liquids.

Such a generic dispenser has a liquid reservoir and a discharge opening through which the liquid can be dispensed. The liquid reservoir of a generic liquid dispenser or a liquid dispenser according to the invention usually has a maximum volume of 200 ml, preferably 50 ml or less. A pump device can be provided to convey the liquid from the liquid reservoir to the discharge opening. Alternatively, pressurization of the liquid directly in the liquid reservoir can also be used to discharge liquid.

In generic dispensers, it is intended that an internal volume of the liquid reservoir is reduced during the course of dispensing. It is therefore not necessary for the removal of liquid to be compensated for by air flowing into the liquid reservoir. Instead, the internal volume is reduced, in particular through the use of a reservoir piston that delimits the internal space of the liquid reservoir.

In the case of liquid dispensers, especially dispensers for dispensing pharmaceutical liquids, it can be very important to keep an eye on the liquid remaining in the liquid reservoir so that complete emptying of the liquid reservoir can be detected in sufficiently good time and a new liquid dispenser can be kept ready.

### Problem and Solution

The invention addresses the problem of providing an advantageous method for detecting the remaining liquid in a liquid reservoir.

To solve this problem, a dispenser for discharging liquids is proposed, which is intended in particular for discharging pharmaceutical or cosmetic liquids and is filled with a corresponding liquid when ready for sale. In particular, a dispenser according to the invention is filled with a highly viscous liquid.

In line with generic dispensers, the dispenser according to the invention has a liquid reservoir and a discharge opening for dispensing the liquid from the liquid reservoir. A dispenser according to the invention is usually designed as a mobile dispenser which can easily be carried in a handbag, for example. In particular, the dispenser preferably has a maximum mass of 100 grams, in particular a maximum mass of 30 grams, without taking into account the liquid contained therein. For the electronic components described below and their power supply, such a dispenser preferably has a battery, preferably a rechargeable battery.

The liquid reservoir has an internal volume that is reduced as the liquid is dispensed. In particular, the liquid reservoir has a reservoir cylinder and a reservoir piston that is displaceable within the reservoir cylinder. In such a design, the reservoir piston moves in the reservoir cylinder as the liquid is discharged.

Designs are possible in which the reservoir piston moves relative to the stationary reservoir cylinder, as well as designs in which the reservoir piston remains stationary relative to the discharge opening, at least after the dispenser has been put into operation, and the reservoir cylinder including its cylindrical jacket wall is moved instead. In designs with a reservoir piston that is stationary during operation, it is preferable for the reservoir piston to be penetrated by an outlet channel. In designs with a moving reservoir piston, an outlet channel in the direction of the discharge opening is preferably provided at the end of the reservoir cylinder opposite the reservoir piston.

The reservoir piston can be a pull piston or a push piston. A combination is also possible.

If the dispenser has a pump device separate from the liquid reservoir, said pump device is connected to the outlet channel of the liquid reservoir via its pump inlet. If liquid is removed from the liquid reservoir by means of the pump device, a vacuum is created in the liquid reservoir and draws the reservoir piston in the direction of a reservoir reduction. In this case, the reservoir piston functions as a drag piston.

Alternatively, the liquid reservoir itself can also be a type of pump chamber. This means that the liquid discharge is caused by an overpressure in the liquid reservoir itself. In this case, the reservoir piston serves the purpose of being pressurized externally and, in particular, manually, thereby increasing the pressure in the liquid reservoir. The reservoir piston is therefore a push piston.

In addition to the manual application of force, it is also possible for a reservoir piston to be tensioned by a spring device, thereby placing the liquid reservoir under permanent pressure. As soon as a dispensing valve is opened on an outlet side of the liquid reservoir or a pump device downstream of the liquid reservoir is actuated, discharge occurs and the reservoir piston is pushed towards the discharge opening by the spring.

A spring device for applying force to the reservoir piston can be used in the pull piston design described above to reduce a possible slip-stick effect between the reservoir cylinder and the reservoir piston.

The dispenser is designed to at least roughly measure the remaining liquid in the liquid reservoir by means of a sensor in order to display and/or otherwise process the data recorded.

In a dispenser according to the invention, the measurement is carried out by means of a distance sensor arrangement. This distance sensor arrangement is designed and arranged to detect the distance between two housing portions. The two housing portions are those of which the spacing changes as the internal volume of the liquid reservoir is reduced.

In particular, the distance measurement can take place between a wall of the reservoir piston or the reservoir cylinder as one housing portion and a second stationary wall as another housing portion. However, other housing portions, which are displaced together with the relative movement of the reservoir cylinder and reservoir piston due to structural coupling, can also form the housing portions used for the distance measurement.

Various measuring principles of the distance sensor arrangement are possible.

When using an optical measuring principle, it can be expedient to manufacture housing portions of the dispenser from transparent material so that the light used for measurement can penetrate these housing portions. In particular, it can be provided that the reservoir cylinder has a transparent wall portion through which the optical measurement takes place. The distance sensor arrangement and the reservoir piston are preferably provided on opposite sides of the transparent wall portion.

For the purposes of the invention, optical measuring principles are understood to be any measuring principles based on the evaluation of electromagnetic waves previously emitted by the distance sensor arrangement.

With optical measuring principles, a light sensor can be present in particular, which detects incident light that was previously emitted by an emitter of the distance sensor arrangement and which was preferably reflected by a wall of the dispenser in order to be thrown back to the light sensor. As a receiver, the light sensor can detect the light intensity and, together with the evaluation electronics, interpret a change in intensity as a change in distance. Alternatively, the transit time of a light signal or another electromagnetic signal can be measured, which changes as the distance between the housing components changes. The light sensor can also be designed as a sensor field, which makes the location of the light incidence measurable. In particular, the light source can be designed as a laser light source. The incidence of the preferably reflected laser beam on the sensor field can, geometrically, allow conclusions to be drawn about the distance between the housing portions.

In the case of acoustic measuring principles, it is intended that the distance sensor arrangement generates an acoustic signal and measures its propagation or, in particular, transit time. In particular, this may be an ultrasonic distance sensor.

For the types of distance sensor designs described, inexpensive measuring modules are available for the most part and can be used. Depending on the purpose of the distance measurement, high accuracy is usually not required.

One possible design envisages that the respective emitter of the sensor arrangement and the corresponding receiver are each permanently attached to the two housing portions for which the distance is to be detected. The emitter and the receiver therefore change their distance from each other as the liquid reservoir continues to empty.

However, a design in which the emitter and the receiver are arranged in a stationary manner relative to each other is preferred, preferably in that they are part of a common sensor unit. This sensor unit is attached to one of the two housing portions and aligned in the direction of the other housing portion. The electromagnetic waves or acoustic waves emitted by the emitter are reflected there and reflected back to the receiver.

The common sensor unit reduces the structural complexity, as these and any other electronic components of the dispenser can be combined in one housing portion.

The common sensor unit preferably has a common sensor housing, which has a wall on or behind which the emitter and the receiver are arranged. Preferably, the housing is provided for attachment to a carrier component of the respective housing portion.

The emitter is designed to emit a signal in a central emitting direction, which preferably corresponds substantially to a central receiving direction of the receiver. The central emitting direction and the central receiving direction form an angle of at most 30°, preferably at most 10°, with a displacement direction of the housing portions relative to each other. The emitter and the receiver are therefore substantially aligned in the direction of displacement.

The use of such a common sensor unit is particularly expedient for simple dispensers, especially manually operated ones, such as dispensers in which the housing portions are manually displaced relative to each other, in particular by applying force via actuating surfaces provided on the housing portions, or dispensers with a pump device for manual actuation, which are equipped with a reservoir piston of which the position is detected by the sensor unit.

The distance sensor arrangement of a dispenser according to the invention serves the purpose of being able to electronically detect the amount of liquid still in the liquid reservoir. Preferably, the distance sensor arrangement is part of the evaluation electronics on the dispenser side, which preferably comprises, in addition to the distance sensor arrangement, an energy source such as, in particular, a rechargeable battery and a processor for processing the sensor data. To transmit the recorded sensor data, the evaluation electronics preferably also have a network interface, in particular a Bluetooth and/or WIFI interface. A 4G or 5G mobile radio interface is also possible. The evaluation electronics can be connected to external devices, in particular a smartphone, via the network interface.

In addition to the distance sensor arrangement, the evaluation electronics can also have other sensors that are used to evaluate dispenser usage. For example, a discharge sensor can be provided that detects an actuation that causes discharging or that detects the discharging itself. It is possible for the distance sensor arrangement to detect the fill level of the liquid reservoir in response to a discharge detected in this way. This allows the energy consumption of the distance sensor arrangement to be kept low.

The evaluation electronics can be an integral part of the dispenser. However, it is considered preferable if the dispenser is divided into two parts. A discharge device comprises the liquid-carrying part and, in particular, the liquid reservoir and the discharge opening. Preferably, there are no electronic components on the discharge device itself. The discharge device is preferably not designed for repeated use with refilling or replacement of the liquid reservoir, but is usually disposed of after emptying.

However, the evaluation electronics, in particular at least the distance sensor arrangement with an emitter and a receiver, is, by contrast, part of a separate evaluation unit. Preferably, all electrical and electronic components of the dispenser are combined here. The evaluation electronics are preferably used in succession with a plurality of discharge devices.

The main purpose of the separation is therefore to use the comparatively complex evaluation unit repeatedly with a plurality of discharge devices. Once a discharge device has been used up by emptying the liquid reservoir, the evaluation unit is detached from the discharge device and the discharge device is disposed of without electronic components. The evaluation unit can then be attached to a new discharge device.

It is advantageous that the distance sensor arrangement is provided for measuring the distance between two housing portions, of which one housing portion is provided on the evaluation unit. The distance sensor arrangement is attached here. The other housing portion is provided on the discharge device and is used to reflect the electromagnetic or acoustic waves.

In such a configuration, the evaluation unit can not only be able to reliably detect the change in position of the reservoir piston in relation to the reservoir cylinder, but also to detect whether the evaluation unit is coupled to a discharge device or has been decoupled from it by evaluating the distance measured by the distance sensor arrangement. If this is greater than the maximum to be expected during operation or if no reflected signal is incident on the receiver in response to an emitted signal, this is an indication of the decoupled state.

The evaluation unit is preferably easy to attach to a new discharge device. In particular, the evaluation unit can be separated from a used discharge device and coupled to a new discharge device without the use of tools. The evaluation unit is preferably coupled to the discharge device in a frictionally engaged or interlocking manner, in particular by means of a detachable snap-in connection or a clamp connection.

The evaluation electronics preferably also comprise a display device. Alternatively, a display device can be dispensed with and the display of a smartphone connected to the evaluation electronics can be used instead to output information.

The display device or, alternatively, the external device coupled to the dispenser, such as a smartphone, can display the fill level of the liquid reservoir based on the sensor data from the distance sensor arrangement. Although it is desirable to detect and display this fill level very precisely, very precise display can also be problematic. Particularly in a design in which the reservoir piston is designed as a pull piston, it may be that the reservoir piston does not immediately move inside the reservoir cylinder due to static friction when liquid is removed and instead a vacuum is created in the liquid reservoir. Only at a later point in time and possibly after liquid has been discharged again from the liquid reservoir does the reservoir piston move again.

Due to the inaccuracy in the detection of the fill level, it is considered advantageous if the fill level is also displayed on the display device or the display of the smartphone with low precision, in particular in a maximum of five discrete steps. This prevents the user from getting a false sense of security because the liquid reservoir is supposedly still full, although it is actually already emptier.

It can be advantageous to use a system with only three steps for displaying the fill level, wherein this can be provided in particular in the form of a traffic light, which displays green when the liquid reservoir is largely filled, orange after a certain amount of liquid has been removed and then red when the level falls below a defined limit value, in order to warn the user that they should have a new dispenser or a new discharge device ready to hand.

### BRIEF DESCRIPTION OF THE DRAWINGS

Further advantages and aspects of the invention can be found in the claims and in the following description of preferred exemplary embodiments of the invention, which are explained below with the aid of the figures.

FIGS. 1 to 4 show a first exemplary embodiment of a dispenser according to the invention and its evaluation unit.

FIG. 5 shows a variant of the dispenser according to FIGS. 1 to 4 with integrated evaluation electronics.

FIGS. 6 and 7 show further exemplary embodiments of a dispenser according to the invention.

### DETAILED DESCRIPTION OF THE EXEMPLARY EMBODIMENTS

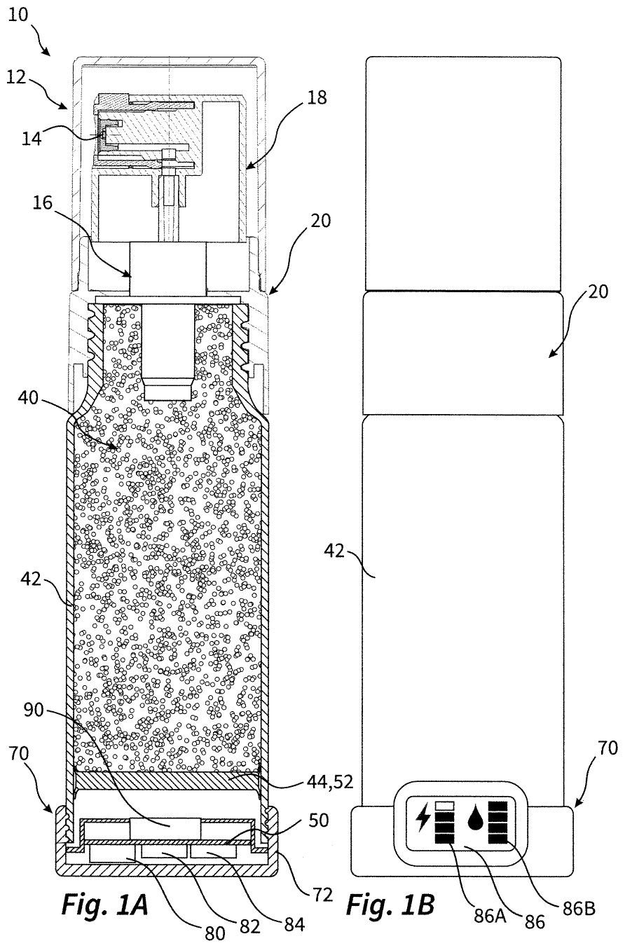

FIGS. 1A to 3 show a first exemplary embodiment of a dispenser 10 according to the invention. This dispenser 10 is formed as a pump dispenser. It has a liquid reservoir 40 on which a discharge head is mounted. This discharge head in turn has a base 20 to which a pump device 60 is attached. An outlet nozzle of the pump device 16 is attached to a depressible actuating pusher 18. If the actuating pusher 18 is pressed down, liquid is pressed out of a pump chamber of the pump device 16 in the direction of a discharge opening 14 and dispensed here. During the return stroke of the pump device 16, liquid is drawn from the liquid reservoir 40.

The liquid reservoir 40 is primarily limited by a reservoir cylinder 42 and a reservoir piston 44 that can be moved within the reservoir cylinder. When liquid is discharged from the largely full level shown in FIG. 1A, the resulting vacuum in the liquid reservoir 40 causes the reservoir piston 44 to be pulled upwards in the manner of a pull piston.

Together, the components described form a functional discharge device 12.

In addition to this discharge device 12, the dispenser 10 has an evaluation unit 70, which is used to detect the fill level of the liquid reservoir 40. The evaluation unit 70 is designed in the form of an easily connectable module, which in the present exemplary embodiment can be attached to the lower end of the reservoir cylinder 42 by means of a thread. The evaluation unit 70 has a distance sensor arrangement 90, the operation of which will be explained below. In addition, the evaluation unit 70 has further electrical or electronic components, namely a battery 80, a processor 82, which is preferably equipped with a memory, and a network interface 84, in particular designed as a Bluetooth or WLAN radio module.

A display device 86 is shown on the outside of the evaluation unit 70 in the manner visible in FIG. 1B. In the present example, this displays two pieces of information, namely the fill level of the battery 80 by means of a first bar 86A and the fill level of the fluid reservoir 40 by means of a second bar 86B. In each case, only five states are provided, namely between 0 and 4 bars.

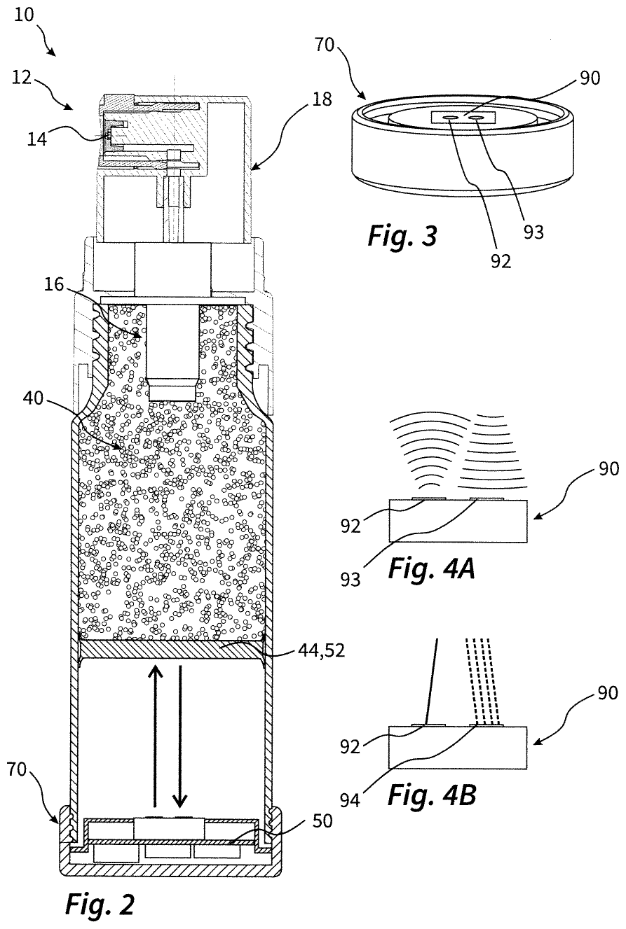

FIG. 2 shows the dispenser 10 in operation after some of the liquid has already been removed from the liquid reservoir 40. The removal of liquid has resulted in the reservoir piston 44 already being displaced slightly upwards.

The distance sensor arrangement 90 is used to measure the position of the reservoir piston 44 and thus the amount of liquid remaining in the liquid reservoir 40. Said distance sensor arrangement has an emitter 92 and a receiver 93, 94, as shown in FIGS. 3 and 4A and 4B. Various optical and acoustic measuring principles are conceivable here.

As shown in FIG. 2, the emitter 92 emits a signal which is reflected by the reservoir piston 44 and thus returns to the distance sensor arrangement 90 and its receivers 93, 94. By measuring the transit time of the corresponding signal or the intensity of the reflected signal detected by the receiver 93, the position of the reservoir piston 44 can be inferred. A further possibility results from the illustration in FIG. 4B. Here it is provided that the emitter emits a bundled signal, in particular in the form of a laser beam, which is reflected by the underside of the reservoir piston 44 and, depending on the distance of the reservoir piston 44 from the evaluation unit 70, falls on various parts of a sensor 94 designed as a sensor field. The location of the incidence of the laser beam is thus dependent on the position of the reservoir piston 44.

The discharge device 12 of the dispenser 10 is intended for single use only. As soon as the liquid reservoir is completely empty, it is not refilled, but the discharge device 12 is disposed of. Before this, however, the evaluation unit 70 is removed, in this case unscrewed, for example. It can then be coupled to a fresh discharge device 12. It is expedient for the evaluation unit 70 to automatically detect this change and send it to an external device via the network interface 84, for example. This detection can also be carried out by means of the distance sensor arrangement 90. In particular, it can be regarded as an indicator of separation if the emitter 92 emits a signal for which no reflection is detected at the receivers 93, 94.

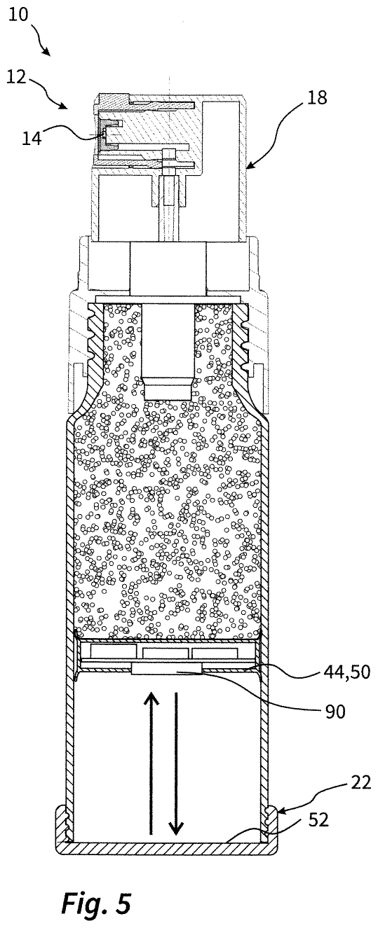

FIG. 5 shows an alternative design of the liquid dispenser 10. Here, the evaluation unit is provided as an integrated evaluation unit and integrated into the reservoir piston 44. By contrast, a lower closure 22, which closes the dispenser 10 at the bottom, is designed without electronic components, unlike in the previous exemplary embodiment. It only forms a housing portion 52, which is used as a reflective surface during the measurement.

As can be seen from FIG. 5, in this configuration the distance sensor arrangement 90 emits a downwardly directed signal, which is reflected at the housing portion 52 and is then detected by the receiver of the distance sensor arrangement 90.

A display device is not provided in the design shown in FIG. 5. Instead, the detected liquid level is transmitted to an external system such as a smartphone and processed and/or displayed there.

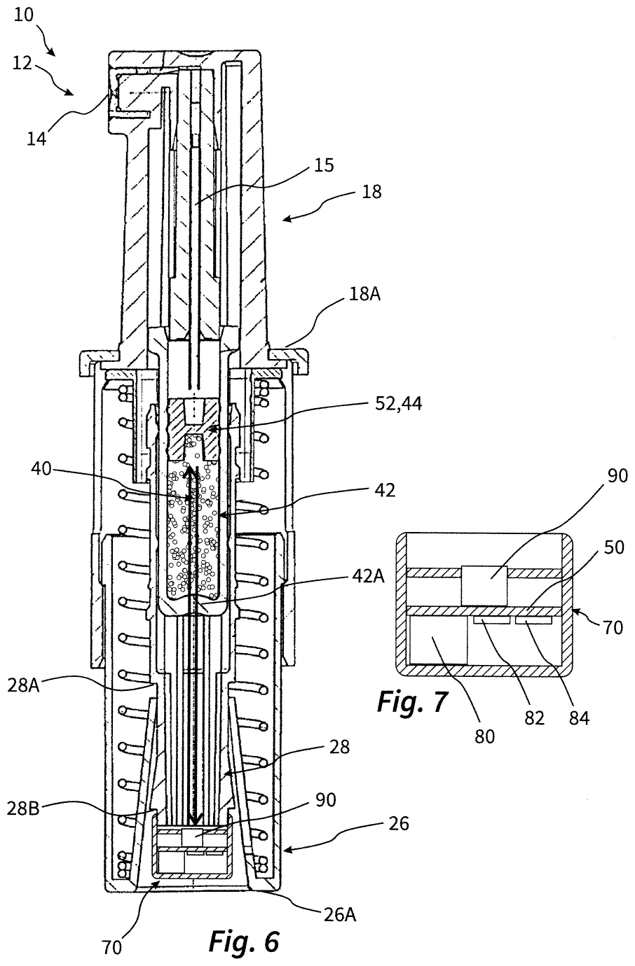

The design in FIG. 6 shows another clearly different dispenser. It is a so-called bidose dispenser, from which liquid can be discharged in two partial strokes. The liquid reservoir 40 of this dispenser 10 is provided in the form of a transparent reservoir cylinder 42, which is closed at its upper end by a reservoir piston 44, for example made of rubber.

If, starting from the state of FIG. 6, a lower actuating pusher 26 is pressed upwards, structures of the actuating pusher 26 hook onto a detent step 28A of a reservoir cylinder carrier 28, so that initially the reservoir cylinder 42 and the reservoir piston 44 are pressed upwards together until a needle 15 pierces through the reservoir piston 44 from above. The continued upward movement of the actuating pusher 26 then leads to the discharge of a first dose of the liquid.

After a first dose has been dispensed, the actuating pusher 26 is first released and pressed back into its initial position by the return spring. Here, the latching arms 26A of the actuating pusher 26 pass over the retaining steps 28B, so that the next actuation causes the retaining arms 26A to latch in place and consequently the second dose of liquid can be dispensed.

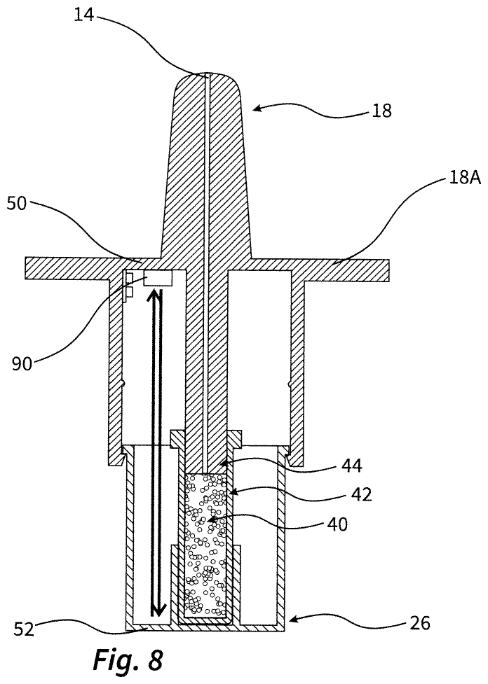

An evaluation unit 70, which is shown again separately in FIG. 7, is attached to the reservoir cylinder carrier 28, which carries the reservoir cylinder 42, to evaluate the liquid discharge. This evaluation unit 70 has a similar structure to that of FIGS. 1 to 4. It also has an upwardly pointing distance sensor arrangement 90, which contains an emitter and a receiver. This distance sensor arrangement determines the distance between the evaluation unit 70 and the reservoir piston 44. To enable this to be done optically, the reservoir cylinder 42 is provided with a wall portion 42A that is transparent for the wavelength range used, at least in its base region. As the arrows in FIG. 6 illustrate, the emitted signal from the distance sensor arrangement 90 thus passes through this wall portion 42A on the base side and through the liquid in the liquid reservoir 40 to the reservoir piston 44, where it is reflected in order to be detected by the receiver of the distance sensor arrangement 90 after passing through the liquid reservoir 40 and the wall portion 42A again.

Again, the measured intensity or the measured transit time of the signal can be used to draw conclusions about how deep the reservoir piston has already been inserted into the reservoir cylinder 42.

FIG. 8 shows a further embodiment of a dispenser 10 according to the invention. The structural design is not entirely dissimilar to FIGS. 6 and 7, since here too an actuating pusher 26 is pushed upwards in the direction of the discharge opening 14 so that a reservoir cylinder 42 is displaced relative to a reservoir piston 44 and the contained liquid is thus pressurized.

The special feature of the design of FIG. 8 is that it is not the position of the reservoir piston 44 or the reservoir cylinder 42 itself that is detected. Instead, the evaluation electronics and distance sensor 90 thereof are arranged away from the liquid reservoir 40 and detect the distance between the finger rest 18A and the distance sensor arrangement 90 attached to it on the one hand and a lower reflective surface on a housing portion 52 on the other hand, which is part of the actuating pusher 26.

1. A dispenser for discharging pharmaceutical and cosmetic liquids, comprising:
a liquid reservoir having an internal volume which is reduced as liquid is dispensed;
a discharge opening for dispensing the liquid from the liquid reservoir;
two housing portions spacing between the two housing portions changing as the internal volume of the liquid reservoir is reduced; and
a distance sensor arrangement for detecting a distance between the two housing portions.

2. The dispenser as claimed in claim 1, wherein
the liquid reservoir has a reservoir cylinder and a reservoir piston displaceable relative to the reservoir cylinder, and
one wall of the reservoir piston forms one of the housing portions.

3. The dispenser as claimed in claim 1, wherein
the distance sensor arrangement is configured as an optical distance sensor.

4. The dispenser as claimed in claim 1, wherein
the distance sensor arrangement is configured as an acoustic distance sensor.

5. The dispenser as claimed in claim 2, wherein
the dispenser has a pump device separate from the liquid reservoir and having a pump inlet and a pump outlet, the pump inlet being connected to the liquid reservoir, and the pump outlet being connected to the discharge opening, and
the reservoir piston is configured as a pull piston displaced by removal of liquid from the liquid reservoir.

6. The dispenser as claimed in claim 2, wherein
the liquid reservoir is configured as a reservoir cylinder having a reservoir outlet connected to the discharge opening, and
the reservoir piston is configured as a push piston displaceable relative to the reservoir cylinder by a manual application of force, wherein the relative displacement forces liquid out of the liquid reservoir towards the discharge opening.

7. The dispenser as claimed in claim 6, wherein
the reservoir piston is stationary relative to the discharge opening and is penetrated by an outlet channel, and
the reservoir cylinder is displaceable relative to the reservoir piston by manual application of force.

8. The dispenser as claimed in claim 6, wherein
the reservoir cylinder has a transparent wall portion, and
the distance sensor arrangement and the reservoir piston are provided on opposite sides of the transparent wall portion.

9. The dispenser as claimed in claim 1,
the distance sensor arrangement has an emitter and a receiver, and
the emitter and the receiver are arranged in a stationary manner relative to each other, and
the emitter and the receiver are aligned in the direction of a reflective housing portion.

10. The dispenser as claimed in claim 9, wherein
the emitter and the receiver are part of a common sensor unit.

11. The dispenser as claimed in claim 10, wherein
the sensor unit is attached to one of the two housing portions and aligned in a direction of the other housing portion.

12. The dispenser as claimed in claim 9,
wherein the dispenser has a battery for operating the distance sensor arrangement.

13. The dispenser as claimed in claim 9, wherein
the emitter is configured to output a signal in a central emitting direction,
the receiver is configured to receive signals in a central receiving direction, and
the central emitting direction and the central receiving direction form an angle of at most 30° with a displacement direction of the housing portions relative to each other.

14. The dispenser as claimed in claim 9, wherein
the dispenser is configured for manual displacement of the two housing portions relative to one another.

15. The dispenser as claimed in claim 10, wherein
the dispenser has a pump device separate from the liquid reservoir and designed for manual actuation,
the liquid reservoir includes a reservoir piston, and
the sensor unit is configured to detect a position of the reservoir piston.

16. The dispenser as claimed in claim 1, wherein
the dispenser has a discharge device having at least the liquid reservoir and the discharge opening, and
the dispenser has an evaluation unit detachable from the discharge device and comprising at least the distance sensor arrangement.

17. The dispenser as claimed in claim 1, wherein
the dispenser has a battery for operating the distance sensor arrangement; and/or
the dispenser has a processor; and/or
the dispenser has a network interface or a wireless network interface for communication with an external device; and/or
the dispenser has a sensor for detecting a discharge process and/or a motion sensor; and/or
the liquid reservoir is filled with a highly viscous liquid, the liquid being a pharmaceutical or a cosmetic liquid.

18. A dispenser system comprising:
a dispenser, the dispenser comprising:
a liquid reservoir, the liquid reservoir having an internal volume reduced as liquid is dispensed;
a discharge opening for dispensing liquid from the liquid reservoir;
two housing portions, a spacing between the two housing portions changing as the internal volume of the liquid reservoir is reduced; and
a distance sensor arrangement for detecting a distance between the two housing portions;
the dispenser system further comprising an electronic display device for displaying a fill level of the liquid reservoir of the dispenser.

19. The dispenser system as claimed in claim 18, wherein
the display device is configured to display the fill level of the liquid reservoir in a maximum of five discrete steps.

20. The dispenser as claimed in claim 3, wherein the distance sensor arrangement has an emitter for emitting light and a receiver for determining light intensity, or the distance sensor arrangement has an emitter and a receiver determining a time period between light emission by the emitter and light reception by the receiver, or the distance sensor arrangement has an emitter comprising a laser light source and a sensor field detecting a location of an incidence of light from the laser light source.

21. The dispenser as claimed in claim 4, wherein the distance sensor arrangement comprises an ultrasonic distance sensor.

22. The dispenser as claimed in claim 10, wherein the common sensor unit has a common sensor housing.

23. The dispenser as claimed in claim 12, wherein the dispenser is configured as a mobile dispenser, the mobile dispenser, when not filled with liquid, having a mass of not more than 100 grams.

24. The dispenser as claimed in claim 14, wherein the dispenser has actuating surfaces on each of the two housing portions.

25. The dispenser as claimed in claim 16, wherein:
the discharge device and the evaluation unit are configured for tool-free coupling and decoupling; and/or
the discharge device and the evaluation unit have coupling surfaces for interlocking or frictionally engaged coupling with one another.

26. The dispenser system as claimed in claim 18, wherein:
the display device is provided on the dispenser; or
the display device comprises an external unit comprising a personal electronic device.
